(19) United States
(12) Patent Application Publication
(10) Pub. No.: US 2005/0213502 A1
(43) Pub. Date: Sep. 29, 2005

(54) Method and system for controlling operation of a network, such as a WLAN, related network and computer program product therefor

(75) Inventors: Gabriella Convertino, Francavilla Fontana (Brindisi) (IT); Francesco Sigona, Tricase (Lecce) (IT); Diego Melpignano, Monza (Milano) (IT); Fabrizio Simone Rovati, Cinisello Balsamo (Milano) (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.I., Agrate Brianza (MI) (IT)

(21) Appl. No.: 11/084,522

(22) Filed: Mar. 18, 2005

(30) Foreign Application Priority Data
Mar. 26, 2004 (EP) 04007275.3

(51) Int. Cl. H04L 12/26

(52) U.S. Cl. 370/229; 370/252; 370/468

(57) ABSTRACT

A system controls operation of a network, such as a WLAN, where at least one information stream is delivered to at least one user via a link that is exposed to variable operating conditions. The system includes a controller module for monitoring the operating conditions of the link, and at least one transcoder for selectively transcoding the information stream by selectively varying one or more transcoding parameters as a function of the monitored operating conditions.

### FIELD OF THE INVENTION

The present invention relates to communication systems, and more particularly, to wireless local area networks (WLANs), such as a WLAN providing audio/video (A/V) streaming services.

### BACKGROUND OF THE INVENTION

WLANs are becoming increasingly popular not only for data, but also for real-time streaming applications. Possible variations of the wireless link in a home environment make the bandwidth available for audio/video streaming a highly variable factor. These variations are due to propagation effects, and interference and traffic generated by other devices, for example.

Consumer electronics (CE) manufacturers are interested in using a domestic WLAN to distribute audiovisual content among entertainment devices and PCs. However, the lack of quality of service (QoS) support in the standard, as well as the variable conditions of the shared wireless channel, make real-time audio/video WLAN distribution in the home a challenging task.

In fact, streaming media over a wireless LAN is relatively straightforward in the ideal case of a channel with a limited error rate and without interference. However, the attenuation of the signal caused by walls and multipath effects of a closed environment like the home, sometimes result in a high (and variable) bit error rate. Furthermore, as wireless equipment in the 2.4 GHz ISM band is becoming commonplace, multiple users may be sharing the same radio spectrum in an uncoordinated way, thereby producing mutual interference.

The effect of a plurality of devices sharing the radio spectrum, and the variable bit error rates associated with the wireless links, results in the bandwidth available for streaming audiovisual content not being constant. The consequence of transmission errors and interference is twofold. First, there is a waste of bandwidth caused by frame retransmissions. Second, such retransmissions increase the frame jitter of a real-time flow that arrives at the receiver. A bigger buffer is therefore needed to compensate for delay variations.

A typical home networking scenario is depicted in FIG. 1, where a set-top box (STB) 110, that also functions as the access point of a WLAN, is receiving an input stream (e.g., TV signals from an aerial broadcast) and distributes it to one or more TV sets 120 in a home by way of a connection 125 included in a Wireless LAN network 140. At the same time, a laptop 130 is accessing the Internet 150 through the WLAN access point 110 using a connection 135 also included in the WLAN 140.

In this scenario, the TCP/IP connection 155 could use a significant portion of the radio bandwidth, especially if the Internet connection is broadband. This situation results in a decrease in the bandwidth available for the real-time stream. In the common case where the video source cannot adapt the source-coding rate to the variable channel capacity, a loss of packets is experienced at the receiver, resulting in an unacceptable video quality. This phenomenon may be bursty and is not predictable.

Those of skill in the art will appreciate that other home WLAN topologies than the one presented in FIG. 1 are possible, wherein the same remarks made in the foregoing apply. Several approaches have been proposed to address the problem of robust real-time streaming over packet networks (including Wireless LANs).

By way of example, in http://www.vixs.com/prod xcode.html, an arrangement is described where a transcoder (Xcode chip) uses channel sampling and real-time transcoding and transrating of MPEG-1, MPEG-2 or MPEG-4 video streams to give a graceful degradation in overall picture quality in response to instantaneous and generally reduced available channel bit rates. Once installed, the Xcoder performs channel monitoring to detect instances of reduced channel bit rate and notifies the controller (a MIPS32 Kmc) of any deviations. The controller then instructs a dedicated transcoding/transrating processor to alter the encoding scheme and level of encoding in real-time to provide the 30 frames/s.

The arrangement in question provides 30 frames per second in all situations. In fact, when scenes with low motion are being transmitted, frames can be skipped without noticeable quality degradation and with a significant bandwidth saving. Of course, this approach implies that the receiver is able to properly deal with skipped frames.

In U.S. published patent application 2002/0054578 a cross-layer approach for adapting multimedia streaming resource allocation to varying channel conditions in a 3G W-CDMA (Wideband Code Division Multiple Access) system is described. This approach can either minimize distortion or power, and specifically targets hybrid delay constrained ARQ (automatic retransmission request) and FEC (forward error correction) mechanisms that are applied to base layers and enhancements layers of a scalable video stream. In particular, the adaptation of the system includes a dynamic allocation of bits to source coding and channel coding depending on measured channel conditions. Source coding bit rate is varied using fine grained scalability and not transcoding as in the present invention. Furthermore, this system is tightly coupled with the 3G cellular communication standard.

In U.S. published patent application 2003/0018794 a system comprising a streaming server, a network gateway and a wireless host is described, where the wireless host and the gateway cooperate to inform the server about congestion in the network and adverse conditions in the wireless channel. As a response to these events, the streaming server can add/remove partial checksums to the video payload depending on the reported bit error rate and can retransmit packets when these are dropped in the wireless link. Therefore the streaming server is adapted to perform retransmissions of video packets that have been lost either because of network congestion or because of high bit error rates in the wireless link. This system inevitably requires client feedback to estimate the network conditions.

In U.S. published patent application 2003/0067872 a system for adapting the characteristics of streaming sources based on network congestion feedback is presented. Network congestion is estimated by the client that is receiving the media stream and is reported back to the server.

In U.S. Pat. No. 6,049,549 a media control approach is described where content is streamed with high QoS demands that is adapted to changing transmission medium characteristics. This approach involves a resource manager that admits traffic according to available resources and a polling manager that polls stations according to their traffic profile. Since Wireless LANs use a CSMA/CA-type (carrier sense multiple access collision avoidance) MAC, the concept of polling is not applicable in this context without changes in the IEEE 802.11 MAC. The system presented in the '549 patent is adaptive only in the sense the polling sequence is changed according to the monitored data transmissions of the stations, i.e., the video stream being transmitted is not affected by such changes.

### SUMMARY OF THE INVENTION

An object of the present invention is to provide an improved wireless transmission system for an audio/video stream that dynamically varies the bit rate of MPEG (moving picture experts group) encoded streams according to the wireless link conditions.

According to the present invention, the above object is achieved by a method having the features set forth in the claims that follow. The invention also relates to a corresponding system, a related network as well as a related computer program product that is loaded in the memory of at least one computer and includes software code portions for performing the steps of the method when the product is run on a computer. As used herein, reference to such a computer program product is intended to be equivalent to reference to a computer-readable medium containing instructions for controlling a computer system to coordinate the performance of the method of the invention. Reference to at least one computer is evidently intended to highlight the possibility for the present invention to be implemented in a distributed/modular fashion.

A preferred embodiment of the invention involves the use of a cross-layer controller (CLC) that operates on information coming from different layers of a protocol stack, and which is able to set critical parameters in various processing blocks in a dynamic way. The CLC operates in strict coordination with the transcoder, the channel estimator and the device used to split the stream into packets. All the blocks above can be implemented in a system-on-chip that resides in the WLAN access point or in a consumer electronic CE device (e.g., a set-top box) that is intended to distribute audio/video content in the home.

Specifically, the arrangement described herein is based on an architecture of the transmission system where the cross-layer controller (CLC) block estimates the wireless LAN conditions, calculates the bandwidth available for audio/video streaming and consequently drives an A/V transcoder. The transcoder can vary the bit rate at which the A/V stream is encoded and/or possibly reduce the spatial and/or temporal resolution thereof.

The combination of CLC and video transcoder can be integrated in a chipset to be used in such devices as set-top boxes and WLAN (wireless LAN) access points that offer optimized A/V streaming support, thereby providing product differentiation with respect to standard WLAN equipment.

In the arrangement described herein the channel conditions are estimated by the streaming server without the cooperation of the client. The main advantage of this approach lies in that no dedicated protocol is needed between the server and the client to report network congestion feedback.

A preferred embodiment of the arrangement described herein uses a transcoder to obtain a compressed video stream with a bit rate following the variations in the wireless bandwidth. Such a strategy typically involves: i) a channel estimator to compute the bandwidth available for audio/video streaming in a wireless LAN, ii) a transcoder to dynamically change the bit rate of the compressed stream, and iii) a streaming server that splits the A/V content into packets and transmits such packets according to the estimated available bandwidth. The operations above are properly coordinated to provide an acceptable quality of the received images.

### BRIEF DESCRIPTION OF THE DRAWINGS

The invention will now be described, by way of example only, by referring to the enclosed figures, wherein:

FIG. 1 is a block diagram of a typical WLAN home networking scenario according to the prior art;

FIG. 2 is a block diagram of a transcoding function in the overall system architecture in accordance with the present invention;

FIG. 3 is a block diagram of a cross-layer controller in accordance with the present invention; and

FIG. 4 is a block diagram of an access point in accordance with the present invention.

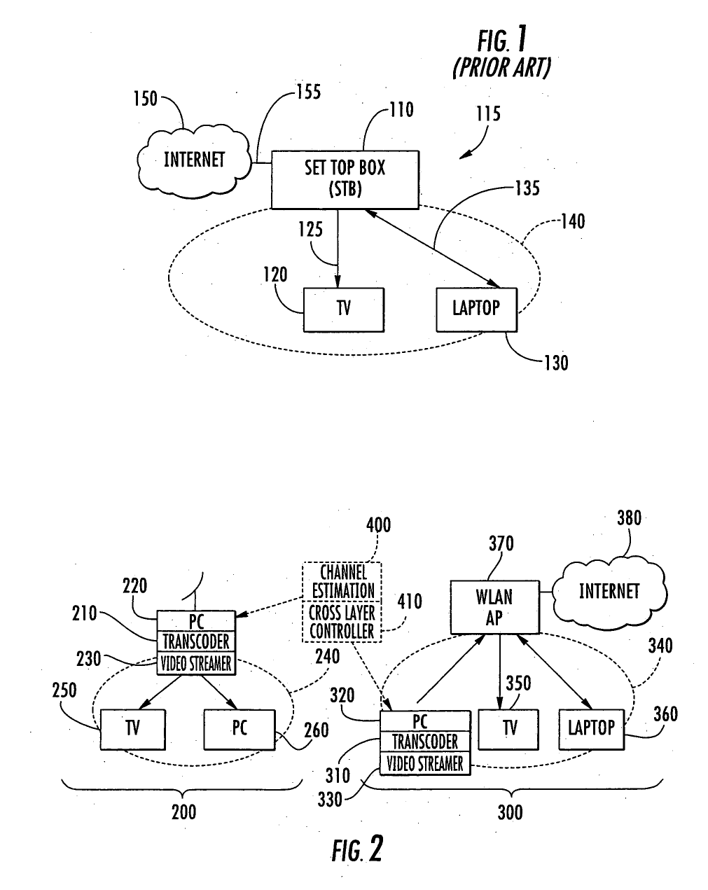

### DETAILED DESCRIPTION OF THE PREFERRED EMBODIMENTS

The arrangement described herein includes a transmission system architecture wherein a cross-layer controller (CLC) block estimates the operating conditions of a wireless LAN. Specifically, an adaptive video transcoder is added to the WLAN access point or station. The adaptive video transcoder dynamically varies the bit rate of MPEG encoded streams depending on the wireless link conditions as measured by a dedicated channel monitor software component.

FIG. 2 shows two possible home network topologies 200 and 300, wherein transcoder blocks 210 and 310 and a channel estimation block 400 are associated to a digital set top box (STB) 220 and a personal computer (PC) 320, respectively.

On the left side of FIG. 2, a video streamer 230 is located in the STB that transmits a video stream received to a TV set 250 using a WLAN connection 240. The STB 220 also communicates with a PC 260.

On the right side of FIG. 2, a video streamer 330 is located in the PC 320 that transmits the video stream to a TV set 350 using a WLAN connection 340. The PC 320 also communicates with a laptop 360. The block 370 indicates a WLAN access point and block 380 indicates the Internet network.

The transcoder blocks 210 and 310, and multimedia streaming blocks 230 and 330 in both network arrangements are driven by a cross-layer controller (CLC) 410 associated with the channel estimation block 400. The controller 410 processes the wireless channels and autonomously decides what portion of the available bandwidths should be dedicated to the video streams.

The transcoder 210 or 310 is instructed to change accordingly the bit rate of the video stream or to apply other stream manipulation functions on a GOP-by-GOP (group of pictures) basis, so the maximum rate of variations is approximately 500 ms, for example. The algorithms used by the transcoder to reduce the video bit rate of a stream are described in detail in the following.

FIG. 3 shows two protocol stacks 500a and 500b of the devices that respectively transmit and receive audio/video content through each of the WLANs shown. Specifically, the two (transmitter/receiver) stacks in question may relate to operation of either of the transcoders 210 or 310.

In the transmitter protocol stack 500a the transmitter (xcoder 510a) takes an MPEG-2 video elementary stream I (either coming from a DVD or from a DVB transport stream) as its input and applies thereto a algorithm to reduce the output bit rate and/or to add robustness to the video stream itself. Optionally, the xcoder 510a may have multiple output streams, for example, when techniques such as fine grained scalability or multiple descriptions are applied. The xcoder 510a may also output the video streams using a different video-encoding standard, such as H.264, for example.

Each xcoder output stream is an elementary stream that is split in packets before transmission. This is the purpose of the network adaptation layer/real-time transport protocol (NAL/RTP) block, 520a in FIG. 3. This function may be accomplished according to different criteria, based on detected network conditions. For example, when the WLAN is congested or is very noisy, shorter packets may be more appropriate than larger ones. On the contrary, in good channel conditions, shorter packets coming from the video xcoder 510a may be aggregated into larger ones to reduce the packet header overhead.

Once the video payload has been assembled an RTP header is added and the packet is transmitted using a UDP (unreliable datagram protocol) socket 530a towards the receiving device. In this embodiment, an IP-based wireless network is assumed, where routing is performed based on the Internet protocol (IP).

The WLAN MAC layer 540a takes care of transmitting the IP packet using the services of the physical layer 550a. Some parameters in the MAC layer 540a can be changed dynamically. For example, when the WLAN is congested, the maximum number of retransmission retries can be reduced which leads to better bandwidth utilization.

Also, the MAC layer 540a collects a set of measurements that can be read by the CLC 560 to estimate the conditions of the wireless channel. The UDP/IP layer 530a communicates with the CLC 560 by the RTCP (real-time transport control protocol) 570.

The corresponding protocol stack 500b at the receiver comprises the elements that are dual to those in the transmitter protocol stack 500a. This protocol stack 500b comprises a decoder 510b, a network adaptation layer/real-time transport protocol (NAL/RTP) block 520b, a UDP/IP layer 530b, a MAC layer 540b and a physical layer 550b.

It will thus be appreciated that various parameters are available at different layers to be dynamically changed to adapt the transmission characteristics of an A/V stream to varying wireless network conditions. This is the responsibility of the cross-layer controller 410.

The cross-layer controller (CLC) block 410 is the core module of the system, and it collects information coming from various elements included in the WLANs monitored. This information may include information as to the 802.11 device driver, the RTP/RTCP software module, and the streaming module. Based thereon, the controller 410 estimates the parameters necessary for an application to optimize its QoS.

Estimating these parameters is not an easy task. The estimation results depend on two factors. One factor is the number and accuracy of available statistics. For example, an estimate based only on streamer statistics cannot account for packet losses during transmission, while an estimate based on WLAN API (application programmers interface) is usually related only to the first transmission hop. If access point centric transmission is used it considers only the station access point link). Moreover, in this last case it is not always possible to obtain accurate estimates of the WLAN statistics.

A second factor is the algorithms used to obtain the estimates. In general, one of the key parameters to be estimated by the CLC 410 is the bandwidth available for streaming A/V content in a WLAN. This depends on the number of stations connected to an access point AP, their traffic patterns and their physical positions. Furthermore, the presence of other devices operating in the same radio band can produce interference, whereby packet retransmissions and overall bandwidth reduction may ensue.

An arrangement adapted to efficiently estimate at any time the bandwidth to be used by real-time streaming application is extremely important in this context. In this respect, it will be appreciated that the specific bandwidth estimation method is in no way a mandatory requirement. The adaptive video streaming arrangement described herein can also be used in connection with other mechanisms for determining the available bandwidth.

An exemplary embodiment of a CLC-WLAN API interface will now be described with reference to a network arrangement including at least one element performing the role of a base station system (BSS). Basically, two kinds of statistics can be identified via such an interface: application statistics and BSS load statistics.

The application (per flow) statistics computed at the MAC station level (Layer 2) on a single hop: from the station to the access point (AP) or from the access point to the station.

If the application flow connects, e.g., a first station (STA1) to a second station (STA2) through the access point, only the STA1-AP information would be available:
i) Data loss rate (% of unsent bits) including RTP/UDP/IP headers: this is the current application data loss rate.
a. Input parameters: application identifier.
b. Output parameters: data loss rate.
ii) Current throughput: Total number of bits successfully transmitted in a second; this is a Layer 2 throughput and includes RTP/UDP/IP headers.
a. Input parameters: application identifier.
b. Output parameters: throughput.
iii) Maximum physical data rate: the physical data rate used by the card over a link; mostly all commercial cards change at runtime this value according to channel conditions.
a. Input parameters: application identifier.
b. Output parameters: physical data rate.
iv) Transmitted packet rate: number of packets transmitted in a second.
a. Input parameters: application identifier.
b. Output parameters: transmitted packet rate. BSS load statistics: these parameters have been included in recent versions of the 802.11e standard (>4.3) to provide an indication of BSS load conditions.
v) Channel utilization: the percentage of time the access point (AP) sensed the medium busy, as indicated by either the physical or virtual carrier sense mechanism; it can provide information about the congestion level of the cell.
vi) Available admission capacity: specifies the remaining amount of bandwidth capacity available in a BSS.
vii) Station count: the station count indicates the total number of STAs currently associated with this BSS.

In the following, the CLC-RTP/RTCP interface CLC-WLAN API interface is described. The RTCP RR is the RTCP receiver reports (see RFC 3550 at http://www.ietf.org) provided by the RTP/RTCP block. The UCL library function to be called by the CLC to get the RR messages is rtp_get_rr( ).

The RR (receiver reports) packets can give feedback about end-to-end transmission between the sender(s) and the receiver(s) by the following information.

The fraction of packets lost within the RTP stream, where each receiver calculates the number of RTP packets lost divided by the number of RTP packets sent as part of the stream. The last sequence number received in the stream of RTP packets. The inter-arrival jitter, which is calculated as the average inter-arrival time between successive packets in the RTP stream.

The RTCP APP is the RTCP application specific packets (see RFC 1889 at http://www.ietf.org) provided by the RTP/RTCP block. APP packets could include parameters read from the MAC and PHY layer of the generating 802.11 entity (station or access point). APP packets may be generated both by the sender(s) and the receiver(s). Each end point can thus get information about its local MAC parameters, and about the parameters of its peer. RTCP APP use is optional since they would use a proprietary protocol format.

A description of the CLC-Transcoder interface is now given based upon some parameter definitions:

Suggested bit rate: the maximum bit rate that an application could use; the estimation should be used by the application to adapt its output bit rate.

Data loss rate: this indicates the data loss rate, i.e., the percentage of data that the receiver application did not get; the transcoder may use this parameter to adapt encoding robustness.

Optimal packet size: this is the packet size that the streamer should use.

Finally, the description of the CLC-Streamer interface is now reported in terms of parameter descriptions.

Streaming bit rate: this is the bit rate measured by the streaming module, calculated as the amount of bits sent to the UDP buffer in a second; the UDP buffer works in write blocking modality when full; it does not include RTP/UDP/IP headers.

Transmitted packet rate: this refers to the number of packets sent to UDP buffer in a second.

Streaming buffer filling: this indicates the level of filling of the streaming buffer.

Recommended Streaming bit rate: the CLC may tell the streamer to change the streaming bit rate; in some cases this value may be different from the transcoding bit rate.

Data loss rate.

Streaming packet size: the CLC may request the streamer to adapt the packet size.

Operation of the arrangement described herein is organized in four basic steps or phases.

Step 1—Collection of Statistics: The CLC 410 periodically collects all the available statistics about the specific flow in which the transcoder is involved. The different kinds of statistics come from the WLAN driver, the RTP/RTCP block and the streamer block. As a rule, no guarantee exists that all of them are available at the same time in the operating environment. In particular, if the receiving station does not support RTCP, then the CLC cannot rely on RTCP statistics.

The time period of updating these statistics is chosen as follows. According to RFC1889 the RTCP statistics are available only each 5 seconds, so this is the minimum time interval to update them. However, in RFC3550 this limit no longer exists for high bit rates, so RTCP statistics are available each 360 kb seconds, where kb is the flow bit rate expressed in kilobits per second.

WLAN statistics: the time period is set to 1 second, therefore the WLAN API will return the Layer 2 throughput, packet loss rate, etc., averaged over 1 second.

Streamer statistics: the time period is set equal to 1 second.

Step 2—Statistics Processing: The statistics collected are then processed to compute an average of them over a certain number of consecutive samples (each of them collected during the previous step or phase). The number of samples and the kind of average are chosen as follows.

RTCP statistics: no processing is performed; content of RTCP reports is used as it is.

WLAN statistics:—the number of samples is set to 10, with the sampling period set to 1 second the average is computed over a time interval of 10 seconds, and the average is an arithmetic average.

Streamer statistics: no processing is done; the values returned by the streamer are already averaged.

The statistics are used to derive an average of the application throughput, data loss rate (DLR), delay and available bandwidth. This data can be compared with expected values to understand if adjustments to runtime application parameters are required.

Operation of the arrangement described herein is totally independent of a specific method used to compute application throughput, DLR, delay and available bandwidth. An example of a possible way to estimate these values is thus described just by way of reference. As already indicated, other methods can be used, without compromising the validity of the overall adaptive streaming approach.

The simplified exemplary algorithm described herein is driven by the observed transmission buffer levels and by MAC level statistics provided by the WLAN device driver.

Other strategies may also take into account: explicit indications of bit rate requested by the application by suitable protocols (RSVP, UPnP); QoS service level agreement violations: whenever a negotiated bit rate (or delay or delay variation) cannot be met by the lower layers because of a congested wireless network, explicit signals are risen and can be handled at the application level by the bandwidth estimator; TCP-friendly RTP rate control algorithms that take round trip time (RTT) into account; explicit packet loss notifications sent by the receiver; and explicit RTP packet retransmission requests sent by the application at the receiver.

Step 3—Computation of Suggested Bit Rate and Optimal Packet Size: This phase can be divided in two sub-steps. A first sub-step performs the computation of the suggested bit rate for each streaming application (transcoder and streamer couple).

Assumption (i): a priority index is assigned to each streaming application (or flow), the CLC 401 will consider this field when resources are allocated to data flows.

Assumption (ii): only a discrete number of bit rate values in the range between the full video quality bit rate and the minimum video quality bit rate can be suggested to the transcoder as a working bit rate, instead of the overall range of values between the same limits. The minimum video quality bit rate is the minimum value of a bit rate for a flow. The transcoder does not try to further decrease the transcoding bit rate under this value. If this value cannot be provided (e.g., due to lack of bandwidth over the network), then the flow should be paused or turned off.

Assumption (iii): it is assumed that a scheduler exist for allocating time slots to the different flows according to their bit rate requirements.

The goal of the following approach is to provide at least the minimum bit rate for each flow, and to allocate the remaining bandwidth to the flows with highest priority. This is achieved also by monitoring the streaming buffer filling. When growing it means that the available bandwidth is less than the required value (and vice-versa). Under the previous assumptions, the bit rate for the transcoders and the streamers are computed, as shown in the following pseudo-code, by way of procedures using well known instructions for BASIC language:

LET F1 be a threshold defined for each flow on the

basis of its characteristics
FOR EACH FLOW FROM HIGH PRIORITY TO LOW PRIORITY DO
IF (the streaming buffer filling > F1)
THEN

LET pre_bw = overall amount of bit rate which may

be preempted from lower priority flows.
(pre_bw is the sum, over all the lower
priority flows, of the difference between
their current streaming bit rate and their
minimum video quality bit rate. That is, it
is supposed that the lower priority flows may
- and will - be forced to work at their
minimum bit rate, to release unnecessary
bandwidth to the upper priority flow which
needs it).

IF (pre_bw > current streaming bit rate)
THEN

keep the current value for the transcoder bit
rate;
set the streaming bit rate (for the streaming
module) equal to the current streaming bit
rate + pre_bw; this should provide a way to
gradually reduce the amount of data
accumulated in the streaming buffer

ELSE

LET bw_need = current streaming bit rate -
pre_bw;
IF (current transcoder bit rate - bw_need >=
minimum bit rate)
THEN

set the current transcoder bit rate to
the greatest bit rate level under the
difference current transcoder bit rate -
bw_need;
set the streaming bit rate (for the
streaming module) equal to the current
streaming bit rate + pre_bw; this should
provide a way to gradually reduce the
amount of data accumulated in the
streaming buffer

ELSE

the CLC will try in a recursive way to
decrease the bit rate of the upper
priority flow - if any exists - as the
current flow.

END IF

END IF

END IF
END LOOP
IF (all the streaming buffer filling are less than F1)
THEN

(the CLC will try to gain further bandwidth and to
allocate it to the highest priority flows first,
by setting the transcoder bit rate and the
streaming bit rate to the next upper bit rate
value)

END IF

The subsequent sub-step or sub-phase performs the computation of optimal packet size. If statistics about different packet sizes and related PER over a specified link are available, then the maximum packet size that provides the expected PER is considered the optimal packet size. If such statistics do not exist or no packet size provides the expected PER, than the application packet size is divided by two until the expected PER is obtained or the minimum packet size is reached.

Step 4—Communication of Computed Parameters to the Transcoder: This step can be performed by any inter-process communication method. The CLC 410 sends to the transcoder a message formatted as follows:

typedef struct {

| | |
|---|---|
| float | bit_rate; |
| float | data_loss_rate; |

int packet_size;

} xmsg;

A special value (−1) is set in the field when it is not available.

Upon receiving the message, the transcoder is expected to change the transcoding process, and to communicate the new target bit rate to the streamer. Of course, the new target bit rate cannot be greater than the original target bit rate, i.e., the bit rate of the original video stream.

Preferably, any transcoder included in the arrangement described herein should be able to optimize quantization, frame rate and size for optimal view given the image content and the net rate available on the channel. The transcoder will indicate the maximum bit rate (the bit rate that the transcoder should produce, in terms of raw video data, i.e., the payload of the network packets only, before any header insertion) and optimal packet size. The transcoder will decide, based on the Q parameter, on the sequence content and on target rate, if to perform frame size reduction and/or frame rate reduction, according to the following pseudo code instructions:

if (bit rate< TH1)

then reduce_frame_rate_and_frame_size( );

else if (bit rate< TH2)

then_reduce_frame_size( );

else if (bit rate< TH3)

then reduce_frame_rate( );

else

keep_original_frame_rate_and_size( );

TH1, TH2, TH3 are three empirical thresholds, with
TH1<TH2<TH3.

After establishing which one out of the four conditions is verified, the transcoder will adapt the quantization step to achieve the desired output bit rate.

The transcoder will also adapt the slicing structure to the network requirements. For example, in case of small packets, the transcoder will typically split larger slices into smaller ones. In case of negligible data_loss_rate, the transcoder could, in case of small slices, fuse them together (as much as allowed by MPEG-2 standard).

The arrangement described herein can be advantageously applied to WLAN access points that are optimized to support video streaming services (in the home or in other environments).

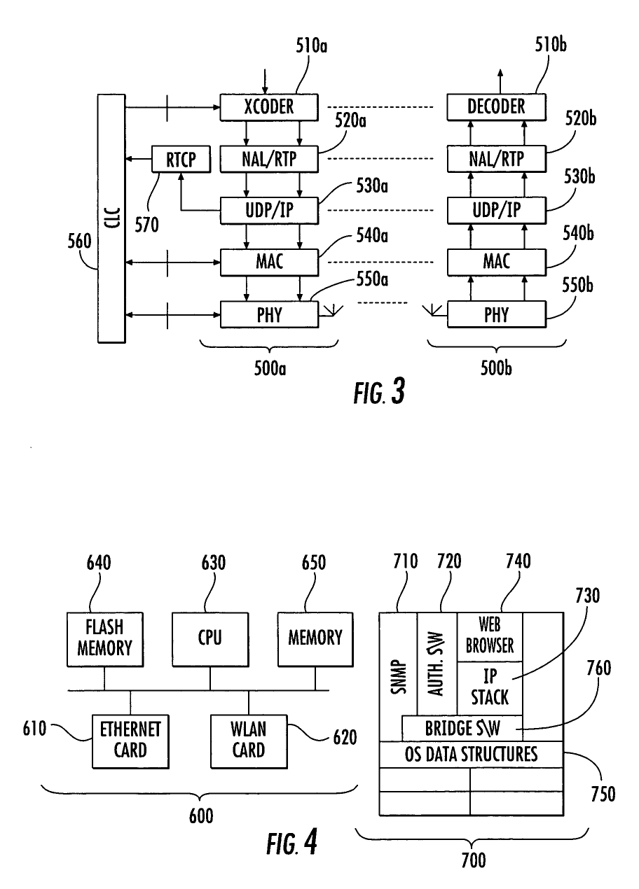

In FIG. 4, a simplified block diagram of the hardware 600 and software 700 structures of a related access point is given. The main hardware blocks of the access point are an Ethernet card 610, one or more Wireless LAN card(s) 620, a CPU 630, a Flash memory 640 and a dynamic memory 650. The WLAN 620 and Ethernet 610 cards may be connected through a PCI bridge (not shown). Their typical behavior is to transmit and receive Ethernet frames from/to the memory using DMA (Direct Memory Access) access and CPU interrupts.

In the CPU 630 (which usually boots an operating system from flash memory upon startup) device drivers take care of handling Ethernet frames both in transmission and reception by preparing/checking their headers and copying their payload into OS 750 (operating system) specific data structures.

Usually, bridging software 760 in the access point takes care of forwarding frames from one network interface to another. Furthermore, the access point AP usually includes an SNMP (simple network management protocol) agent 710 that enables remote control of the device, authentication software 720 to give access only to allowed clients, an IP stack 730 (to enable remote monitoring through SNMP) and a Web browser 740 for configuration purposes.

The present invention is applicable not only to traditional WLAN access points, but also to such devices as set-top boxes, TV sets, personal computers or other equipment that are adapted to act as a WLAN access point. This invention provides adaptive video streaming in a wireless LAN so that a video stream bit rate can be varied, video format resized or frames skipped depending on the measured channel conditions.

Consequently, without prejudice to the underlying principles of the invention, the details and embodiments may vary, also appreciably, with reference to what has been described by way of example only, without departing from the scope of the invention as defined by the claims that follow.

1-30. (canceled)

31. A method for controlling operation of a network in which an information stream is being delivered to at least one user via at least one link that is exposed to variable operating conditions, the method comprising:
monitoring the operating conditions of the at least one link; and
transcoding the information stream by selectively varying at least one transcoding parameter as a function of the monitored operating conditions.

32. A method according to claim 31, wherein the at least one link comprises a wireless link.

33. A method according to claim 31, wherein the network comprises a local area network.

34. A method according to claim 31, wherein the network comprises a wireless local area network.

35. A method according to claim 31, wherein the information stream comprises a media stream.

36. A method according to claim 35, wherein the media stream comprises at least one of an audio stream, a video stream and an audio/video stream.

37. A method according to claim 35, wherein the media stream comprises at least one of an MPEG and H.264 encoded stream.

38. A method according to claim 31, wherein the at least one transcoding parameter comprises at least one of a bit-rate of the information stream, a spatial resolution of the information stream, and a temporal resolution of the information stream.

39. A method according to claim 31, wherein the information stream comprises transmission packets; and further comprising:
estimating an available bandwidth for transmitting the information stream over the at least one link; and
estimating at least one of varying a bit rate of the information stream, and splitting contents of the transmission packets according to the estimated available bandwidth.

40. A method according to claim 31, wherein the information stream comprises a video stream, and the transcoding comprises GOP-by-GOP processing of the video stream.

41. A method according to claim 31, wherein the information stream comprises packets; wherein the monitoring comprises detecting the at least one link being at least one of congested and noisy; and wherein the transcoding comprises reducing lengths of the packets as the at least one link becomes at least one of more congested and noisy.

42. A method according to claim 31, wherein the transcoding comprises generating corresponding transmitter and receiver protocol stacks for IP packet transmission, each protocol stack being arranged in a cross-layer controlled arrangement comprising:
a transcoder layer;
a network adaptation/real-time transport protocol (NAL/RTP) layer coupled to the transcoder layer;
a UDP/IP layer coupled to the NAL/RTP layer;
a MAC layer coupled to the UDP/IP layer; and
a physical layer coupled to the MAC layer.

43. A method according to claim 31, wherein the operating conditions being monitored for the at least one link comprises at least one of:
a data loss rate over the at least one link;
a current throughput over the at least one link; and
a maximum physical data rate over the at least one link.

44. A method according to claim 31, wherein the network comprises a base station associated with the least one link; and wherein the operating conditions being monitored for the at least one link comprises at least one of:
channel utilization over the at least one link;
available admission capacity over the at least one link; and
a total number of stations associated with the base station.

45. A system for controlling operation of a network in which an information stream is being delivered to at least one user via at least one link that is exposed to variable operating conditions, the system comprising:
a controller module for monitoring the operating conditions of the at least one link; and
at least one transcoder for transcoding the information stream by selectively varying at least one transcoding parameter as a function of the monitored operating conditions.

46. A system according to claim 45, wherein the at least one link comprises a wireless link.

47. A system according to claim 45, wherein the network comprises a local area network.

48. A system according to claim 45, wherein the network comprises a wireless local area network.

49. A system according to claim 45, wherein the information stream comprises a media stream.

50. A system according to claim 49, wherein the media stream comprises at least one of an audio stream, a video stream and an audio/video stream.

51. A system according to claim 49, wherein the media stream comprises at least one of an MPEG and H.264 encoded stream.

52. A system according to claim 45, wherein the at least one transcoding parameter comprises at least one of a bit-rate of the information stream, a spatial resolution of the information stream, and a temporal resolution of the information stream.

53. A system according to claim 45, wherein the information stream comprises transmission packets; and further comprising a channel estimator for:
estimating an available bandwidth for transmitting the information stream over the at least one link; and
estimating at least one of varying a bit rate of the information stream, and splitting contents of the transmission packets according to the estimated available bandwidth

54. A system according to claim 45, wherein the information stream comprises a video stream, and the transcoding comprises GOP-by-GOP processing of the video stream.

55. A system according to claim 45, wherein the information stream comprises packets; wherein the monitoring by said controller module comprises detecting the at least one link being at least one of congested and noisy; and wherein the transcoding by said at least one transcoder comprises reducing lengths of the packets as the at least one link becomes at least one of more congested and noisy.

56. A system according to claim 45, wherein the transcoding by said at least one transcoder comprises generating corresponding transmitter and receiver protocol stacks for IP packet transmission, each protocol stack being arranged in a cross-layer controlled arrangement comprising:
a transcoder layer;
a network adaptation/real-time transport protocol (NAL/RTP) layer coupled to said transcoder layer;
a UDP/IP layer coupled to said NAL/RTP layer;
a MAC layer coupled to said UDP/IP layer; and
a physical layer coupled to said MAC layer.

57. A system according to claim 45, wherein the operating conditions being monitored by said controller module for the at least one link comprises at least one of:
a data loss rate over the at least one link;
a current throughput over the at least one link; and
a maximum physical data rate over the at least one link.

58. A system according to claim 45, wherein the network comprises a base station associated with the least one link; and wherein the operating conditions being monitored by said controller module for the at least one link comprises at least one of:
channel utilization over the at least one link;
available admission capacity over the at least one link; and
a total number of stations associated with the base station.

59. A local area network (LAN) comprising:
at least one user device for receiving an information stream via at least one user link that is exposed to variable operating conditions;
a controller module for monitoring the operating conditions of the at least one link; and
at least one transcoder for transcoding the information stream by selectively varying at least one transcoding parameter as a function of the monitored operating conditions.

60. An LAN according to claim 59, wherein the LAN comprises a wireless LAN; and wherein the at least one link comprises a wireless link.

61. An LAN according to claim 59, wherein the information stream comprises at least one of an audio stream, a video stream and an audio/video stream.

62. An LAN according to claim 59, wherein the at least one transcoding parameter comprises at least one of a bit-rate of the information stream, a spatial resolution of the information stream, and a temporal resolution of the information stream.

63. An LAN according to claim 59, wherein the information stream comprises transmission packets; and further comprising a channel estimator for:
estimating an available bandwidth for transmitting the information stream over the at least one link; and
estimating at least one of varying a bit rate of the information stream, and splitting contents of the transmission packets according to the estimated available bandwidth.

64. An LAN according to claim 59, wherein the information stream comprises a video stream, and the transcoding comprises GOP-by-GOP processing of the video stream.

65. An LAN according to claim 59, wherein the information stream comprises packets; wherein the monitoring by said controller module comprises detecting the at least one link being at least one of congested and noisy; and wherein the transcoding by said at least one transcoder comprises reducing lengths of the packets as the at least one link becomes at least one of more congested and noisy.

66. An LAN according to claim 59, wherein the transcoding by said at least one transcoder comprises generating corresponding transmitter and receiver protocol stacks for IP packet transmission, each protocol stack being arranged in a cross-layer controlled arrangement comprising:
a transcoder layer;
a network adaptation/real-time transport protocol (NAL/RTP) layer coupled to said transcoder layer;
a UDP/IP layer coupled to said NAL/RTP layer;
a MAC layer coupled to said UDP/IP layer; and
a physical layer coupled to said MAC layer.

67. An LAN according to claim 59, wherein the operating conditions being monitored by said controller module for the at least one link comprises at least one of:
a data loss rate over the at least one link;
a current throughput over the at least one link; and
a maximum physical data rate over the at least one link.

68. A computer-readable medium having computer-executable instructions for execution by a computer, the computer-readable medium for controlling operation of a network in which an information stream is being delivered to at least one user via at least one link that is exposed to variable operating conditions, the computer-executable instructions comprising:
a first data field containing data for monitoring the operating conditions of the at least one link; and
a second data field containing data for transcoding the information stream by selectively varying at least one transcoding parameter as a function of the monitored operating conditions.

69. A computer-readable medium according to claim 68, wherein the LAN comprises a wireless LAN; and wherein the at least one link comprises a wireless link.

70. A computer-readable medium according to claim 68, wherein the information stream comprises at least one of an audio stream, a video stream and an audio/video stream.

71. A computer-readable medium according to claim 68, wherein the at least one transcoding parameter comprises at least one of a bit-rate of the information stream, a spatial resolution of the information stream, and a temporal resolution of the information stream.

72. A computer-readable medium according to claim 68, wherein the information stream comprises transmission packets; and further comprising:
a third data field containing data for estimating an available bandwidth for transmitting the information stream over the at least one link; and
a fourth data field containing data for estimating at least one of varying a bit rate of the information stream, and splitting contents of the transmission packets according to the estimated available bandwidth

73. A computer-readable medium according to claim 68, wherein the information stream comprises a video stream, and the transcoding by the second data field comprises GOP-by-GOP processing of the video stream.

74. A computer-readable medium according to claim 68, wherein the information stream comprises packets; wherein the monitoring by the first data field comprises detecting the at least one link being at least one of congested and noisy; and wherein the transcoding by the second data field comprises reducing lengths of the packets as the at least one link becomes at least one of more congested and noisy.

75. A computer-readable medium according to claim 68, wherein the operating conditions being monitored by the first data field for the at least one link comprises at least one of:
a data loss rate over the at least one link;
a current throughput over the at least one link; and
a maximum physical data rate over the at least one link.
